(19) United States
(12) Patent Application Publication
(10) Pub. No.: US 2021/0200905 A1
(43) Pub. Date: Jul. 1, 2021

(54) METHODS AND APPARATUS FOR PROTECTING COMPUTER DATA USING HIDDEN WIRELESS DATA COMMUNICATIONS

(71) Applicant: SAFE12, INC., San jose, CA (US)

(72) Inventors: Roger T. Huitt, Soquel, CA (US); Qing Wang, Palo Alto, CA (US)

(21) Appl. No.: 16/731,385

(22) Filed: Dec. 31, 2019

(51) Int. Cl. G06F 21/74; H04W 4/80; H04W 76/14; H04W 12/00; G06F 21/85

(52) U.S. Cl. CPC G06F 21/74; H04W 4/80; G06F 2212/1052; H04W 12/003; G06F 21/85; H04W 76/14

(57) ABSTRACT

Methods and apparatus consistent with the present disclosure may include multiple different sets of different electronic components that may communicate with each other based on a position of a switch. A first set of electronic components may send data to a second set of wireless components using wireless communication signals when the switch is in a first position. A third set of electronic components may send data to the second set of wireless components using wireless communication signals when the switch is in a second position. The switch may be hidden such that the presence of the third set of electronic components may be hidden from a casual observer. Apparatus consistent with the present disclosure form a new type secure electronic device that can protect computer data in new ways by obfuscating the presence of one or more sets of electronic components that are included within an enclosure.

### BACKGROUND OF THE INVENTION

### Field of Invention

The present invention generally relates to protecting sensitive data from being accessed by unauthorized persons. More specifically the present invention is directed to securing data by isolating different sets of electronic components using wireless communication links.

### Description of the Related Art

Threats to secure computer data include the prying eyes of individuals that may see data displayed on a computer screen and software that can compromise or steal computer data. The government of the United States (US) is very concerned that individuals without proper security clearances may view documents that are considered classified, secret, or top secret. Any individual who may walk into a room where sensitive documents are located or displayed on a display is a security risk. Even individuals that are not physically in a room may be a security threat. For example, secure materials may be viewed by individuals who are far from a display screen by viewing that screen using a pair of binoculars or a telescope. Secure materials may also be viewed by persons who have placed hidden cameras in a room where secure materials are viewed. While the US government does setup facilities where sensitive data may be viewed in an environment free from prying eyes, setting up such facilities in new locations is an expensive and time consuming task. What are needed are new method and apparatus that allow secure data to be viewed virtually at any time and virtually at any location in a manner that maintains the highest level of security.

Malware, computer viruses, and eavesdropping software have been used to steal sensitive information, destroy computer data, and hold computer data for ransom. Malware broadly refers to malicious software designed to infiltrate and/or damage a computer system and/or network without an owner of a computer or computer network being aware that their data has been compromised. Another problem that affects computing devices is the dissemination of undesired advertisements and messages. Damage from such “spam” messages or malware are not limited to time lost sorting through these undesired messages, yet also can include “phishing” attacks that can steal personal information or attacks like the “I Love You” virus that spawn excessive email traffic with the intent to crash a computer network.

Generally, malware can be any software program that includes code that executes without the knowledge or authorization of an owner or user of a computing device. Malware is typically distributed by parties with nefarious intent. Malware is commonly used steal or destroy computer data or to snoop or spy the actions of a user when the user operates a computer. Malware is also frequently used to damage a computer or to damage computer data. For example, malware may be used to steal personal or financial information, blackmail computer users by denying access to their own data unless or until a fee is paid, damage infected computers by damaging data stored on those infected computers, or to steal classified information.

Because of the threats posed to computing devices in general and because of government security requirements, new methods and apparatus are needed to secure these computing devices from exploitation by various forms of malicious program code or by prying eyes.

### SUMMARY OF THE CLAIMED INVENTION

The presently claimed invention relates to a method, a non-transitory computer readable storage medium, or an apparatus that performs functions consistent with the present disclosure. An apparatus consistent with the presently claimed invention may include a first, a second, and a third set of electronic components where the first set of electronic components includes a first set of wireless data transfer components and the second set of electronic components includes a second set of wireless data transfer components. Apparatus consistent with the present disclosure may include a switch that includes a first position and a second position. The third set of electronic components may be controllably coupled to communicate data between the first set of electronic components or the second set of electronic components based on a position of the switch corresponding to a first position or a second position. The first set of electronic components may send data for display on the display when the switch position corresponds to the first position and the second set of electronic components may send data for display on the display when the switch position corresponds to the second position.

A method consistent with the present disclosure may include executing instructions out of a first memory by a first processor when a switch is in a first position. This method may also include providing a first set of data for display on a display via a first set of wireless data transfer components when the switch is in the first position and this data may be displayed on the display based on execution of the instructions by the first processor out of the first memory. A second processor may then execute instructions out of a second memory when the switch is in a second position and a second set of data may be provided for display on the display via a second set of wireless data transfer components when the switch is in the second position. The second set of data may be displayed on the display based on the execution of the instructions out of the second memory by the second processor.

A non-transitory computer readable storage medium having embodied thereon one or more programs executable by one or more processors to implement a method for protecting computer data. Here again the method may include executing instructions out of a first memory by a first processor when a switch is in a first position. This method may also include providing a first set of data for display on a display via a first set of wireless data transfer components when the switch is in the first position and this data may be displayed on the display based on execution of the instructions by the first processor out of the first memory. A second processor may then execute instructions out of a second memory when the switch is in a second position and a second set of data may be provided for display on the display via a second set of wireless data transfer components when the switch is in the second position. The second set of data may be displayed on the display based on the execution of the instructions out of the second memory by the second processor.

### BRIEF DESCRIPTION OF THE DRAWINGS

FIG. 1 illustrates a computing device that includes an isolated computing environment and a computing environment that may communicate with other computing devices over a communication interface.

FIG. 2 illustrates two different computing devices that each have a first and a second environment where data may be transmitted between the first and the second environment using light emissions.

FIG. 3 illustrates an exemplary topology of aligned light emitters and receivers that may be used to transmit data between different computing environments at a computing device.

FIG. 4A illustrates a configuration where three different components of a system are communicatively disconnected/isolated from each other.

FIG. 4B illustrates an exemplary configuration consistent with the present disclosure.

FIG. 4C illustrates a second exemplary configuration consistent with the present disclosure.

FIG. 5 illustrates exemplary switches that may be used to connect an intelligent switch to either a secondary environment or a primary environment

FIG. 6 illustrates components that maybe included in a primary environment and in a secondary environment.

FIG. 7 illustrates an exemplary flow of actions consistent with the present disclosure that may be performed when a user wishes to access content from a remote computing device.

FIG. 8 illustrates different environments where a set of components in a user interactive environment may receive data from and provide data to electronics included in a communication environment or in an isolated environment depending on the position of a switch

FIG. 9 illustrates different environments where a set of components in a user interactive environment may receive data from and provide data to electronics included in a communication environment or in an isolated environment depending on the position of a switch.

FIG. 10 illustrates a computing system that may be used to implement an embodiment of the present invention.

### DETAILED DESCRIPTION

The present disclosure is directed to protecting sensitive information from being viewed or acquired by persons that are not authorized to view or receive this sensitive information. The present disclosure is also directed to preventing forms of malicious software from exploiting a computer. Methods and apparatus consistent with the present disclosure may protect primary computing environments and data from being exploited by individuals that do not have security clearances. Patent application Ser. No. 16/286,017, filed Feb. 26, 2019, entitled “Securing a Computer Processing Environment from Receiving Undesired Content” is incorporated by reference into the present application.

Methods and apparatus consistent with the present disclosure may include multiple different sets of different electronic components that may communicate with each other based on a position of a switch. A first set of electronic components may send data to a second set of wireless components using wireless communication signals when the switch is in a first position. A third set of electronic components may send data to the second set of wireless components using wireless communication signals when the switch is in a second position. The switch may be hidden such that the presence of the third set of electronic components may be hidden from a casual observer. Apparatus consistent with the present disclosure form a new type secure electronic device that can protect computer data in new ways by obfuscating the presence of one or more sets of electronic components that are included within an enclosure.

Methods and apparatus consistent with the present disclosure may include different computers that may each include its own processor and memory. Data received by a first computer within an apparatus may be scanned for malicious program code before that data is allowed to be provided to a second computer within the apparatus. Data transferred between different computing devices or sets of electronics that are contained within a single enclosure may be transmitted using wireless communication devices. Such wireless communication devices may include one or more light emitting diodes (LEDS) and receivers that may transfer data using light or infrared transmissions. Alternatively or additionally these wireless communications may be transmitted using electromagnetic induction or radio frequency signals.

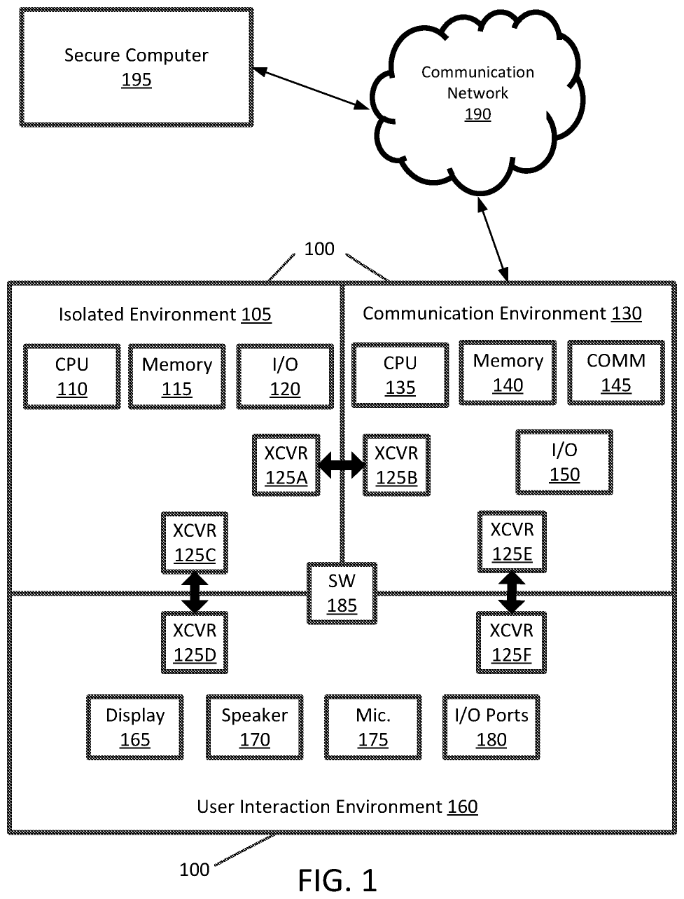

FIG. 1 illustrates a computing device that includes an isolated computing environment and a computing environment that may communicate with other computing devices over a communication interface. FIG. 1 includes isolated environment 105, a communication environment 130, user interaction environment 160, and switch 185 that may be contained within a single enclosure 100. Isolated environment 105 includes CPU (processor) 110, memory 115, input/outputs 120, wireless transceiver (XCVR) 125A, and wireless transceiver 125C. Communication environment 130 includes CPU (processor) 135, memory 140, communication interface 145, inputs/outputs 150, wireless transceiver 125B, and wireless transceiver 125E. The user interface/interface ports of FIG. 1 include display 165, speaker 170, microphone 175, other inputs/outputs 180, wireless transceiver 125D, and wireless transceiver 125F. User interaction environment 160 includes display 165, speaker 170, microphone 175, I/O ports 180, transceiver 125D, and transceiver 125F. FIG. 1 also includes communication network 190 and secure computer 195 and communication network 190 may allow components at communication environment 130 to communicate with secure computer 195.

The switching of switch 185 from a first position to a second position may cause components in user interaction environment 160 to switch between communicating with components in communication environment 130 to communicating with components in isolated environment 105. The switching of switch 185 may cause CPU 110 at isolated environment 105 to begin executing instructions out of memory 115 and may cause communications to be sent between isolated environment 105 and user interaction environment 160 via transceivers 125C and 125D. At this time CPU 110 may send or receive data from any of the components in user interaction environment 160 via inputs/outputs 120 and transceiver 125C. Inputs/outputs 120 may provide signals to transceiver 125C or receive signals from transceiver 125C that allow CPU 110 to receive and evaluate data transferred via those signals. For example inputs/outputs 120 could perform the function of a serializer or a de-serializer that converts data in form a set of parallel bits to a serial data stream of bits or visa-versa. Alternatively or additionally, inputs/outputs may include analog to digital converters or digital to analog converts that convert data from a digital set of bits to an analog signal or visa-versa.

When switch 185 is in the first position, CPU 135 of communication environment 130 may execute instructions out of memory 140 when information is sent to or received from components in user interaction environment 160 via transceiver 125E and transceiver 125F. CPU 135 may send or received this information via inputs/outputs 150. At this time power may be applied to transceiver 125E and transceiver 125F, when switch 185 is switched to a second position, power may be removed from transceiver 125E and possibly from transceiver 125F in order to eliminate any possibility that components in communication environment 130 can communicate with components in user interaction environment 160. The switching of switch 185 to the second position may cause power to be applied to transceiver 125C and possibly to transceiver 125D such that the components in isolated environment 105 can communicate with components in user interaction environment 160.

Switch 185 may be a switch that is hidden from view. For example, switch 185 could be hidden under an enclosure cover or switch 185 could be a magnetic switch that switches position when a magnet is place near switch 185. The various transceivers (125A-125F) can be any form of wireless transceiver known in the art, yet may be transceivers that can only transmit wireless signals over short distances or that transmit wireless signals that are contained within enclosure 100. As such, transceivers 125A-125F used in apparatus consistent with the present invention may transmit light (e.g. infrared or other) or may transmit low powered radio signals. Transceivers 125A-125F may thus include or be infrared transmitters, infrared receivers, infrared transceivers, or be RF transmitter/receivers like those produced by Keyssa (e.g. the Keyssa Kiss).

Components in communication environment 130 may also be able to communicate with components in isolated environment 105 via transceivers 125A and 125B. Here again these communications may be allowed (turned on) or not allowed (turned off) based on a position of switch 185 or a position of another switch (not illustrated in FIG. 1). In operation, components in communication environment 130 may receive data via communication interface 145 and communication network 190 that was transmitted from secure computer 195. After receiving this data, CPU 135 may execute instructions out of memory 140 to test that received data for malware. If malware is found in data received via communication interface 145, that data may be discarded and a message may be provided to a user via display 165 or speaker 170 indicated that the received data included malware. When the received data is found to not include malware, a message indicating that could be provided to the user after which the user could switch a switch into a position that allows data to be transmitted between communication environment 130 and isolated environment 105.

While in certain instances, communication network 130 may use communication interfaces capable of communicating via public accessible networks such as the cloud or Internet, communication network 190 may be any communication network known in the art that may or may not communicate via a public accessible network. In certain instances, communication network 190 may be a proprietary network, as such, communication network 190 may be a satellite communication network, be a ultra-low frequency communication network, be a radio communication network, or be a network that communicates via light. As such, communications sent via communication network 190 may be transmitted using any standard or any proprietary communication technology wired or wireless. In certain instances, apparatus consistent with the present disclosure may include or be coupled to a device that receives signals via space, the atmosphere, or the water (e.g. the ocean). Ultra-low frequency communications are transmitted through the waters of the ocean to submarines that may receive these ultra-low frequency communications via a submerged antenna. Alternatively, communication wireless or wired network may be any computer network 190 known in the art including a cellular network, an 802.11 network, a Bluetooth network, or an Ethernet network.

Display 165, speaker 170, and microphone 175 of FIG. 1 are devices that may provide information to users, that may receive information from users, or both. Display 165 could be a touch screen display that receives user selections or commands via a graphical user interface (GUI) displayed on the display. Audio queues could be provided to a user via speaker 170 and audio information could be received from microphone 175. Input output ports 180 or inputs/outputs 150 of FIG. 1 could allow a user to connect peripheral devices to a computing device, for example to connect a camera or a universal serial bus (USB) data storage device to a computing device.

The various environments illustrated in FIG. 1 may be nearly completely electrically isolated from each other. These different environments may share one or more power supplies or power supply voltages. In certain instances, a combination of manual switches and transistor (e.g. field effect or bipolar) switches may be used to perform switching functions that may include applying or removing power supply voltages to components in an environment that is not being used. For example, when components in communication environment 130 are configured to communicate with user interaction environment 160, components 135, 140, 145, 150, and 125E in communication environment may be provided power, where components in isolated environment 105 could be powered off. A single FET switch could be used to selectively provide or remove power supply voltages to components to allow those components to be turned on or turned off depending on the setting of a single switch. By selectively removing power from components not being used, electromagnetic radiation emitted from powered off components could not be sensed or received by a sensor or antenna. This would mean that a person monitoring radiation emitted from an electronic device would not be able to identify the presence of additional electronic components based on the detection of anomalous electromagnetic radiation emissions. When a processor executes more instructions per unit time, that processor will emit more electromagnetic radiation. In an instance, when communication environment 130 was active, yet CPU 135 was not executing many instructions per unit time, communication environment 130 should emit lower levels of electromagnetic radiation. Furthermore, increasing the number of instructions executed per unit time by adding more processing tasks would increase an amount of electromagnetic radiation emitted from communication environment 130. If, however, a person were monitoring emitted radiation at a time of low processor 135 activity (a relatively few number of processing tasks being performed) and the measured emitted radiation did not change in a manner that corresponds to the low processor activity state, the person could identify that some other electronics in enclosure 100 must be active. This could lead the person to identify that enclosure 100 included CPU 110 is executing instructions out of memory 115 and such a finding could result in the person identifying that a computing device has dual functionality. As such, methods and apparatus consistent with the present disclosure would not only optimize power usage, these methods and apparatus may allow a CIA agent's user device to evade detection in an instance when a potential adversary tested that device for unusual activity.

While FIG. 1 includes isolated environment 105, communication environment 130, and user interaction environment 160, apparatus consistent with the present invention may include an additional environment that may also include processors and memories. In such an instance, this additional environment may be configured to test data received by communication environment 130 before that data is provided to isolated environment 105. Here again this additional environment may selectively communicate with the other computing environments via wireless connections that are enabled or disabled, or that are powered on or powered off using one or more switches. The black double arrows between transceivers 125A & 125B, 125C & 125D, and 125E & 125F are representative of wireless or non-contact data transmissions that may be activated at an apparatus consistent with the present disclosure.

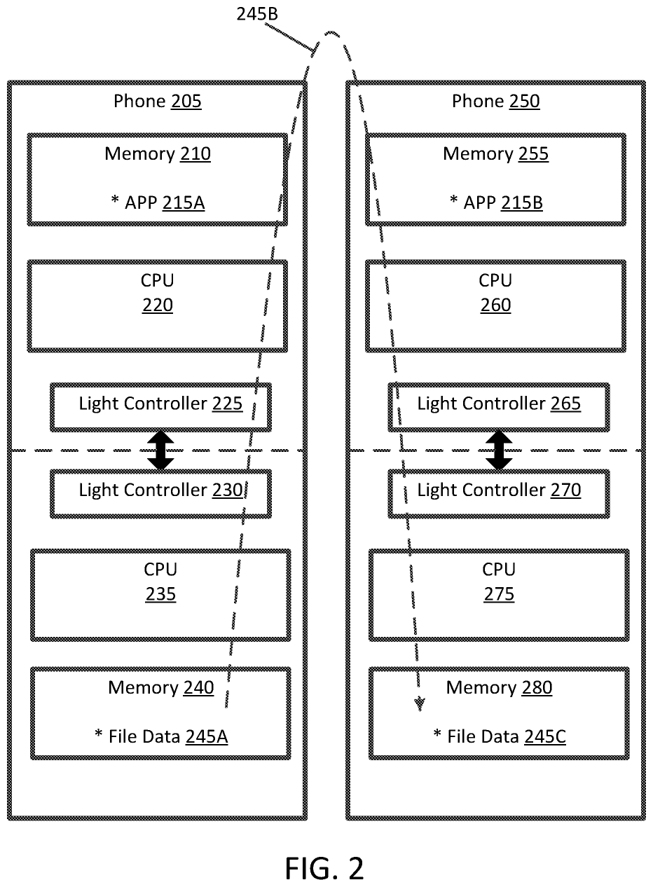

FIG. 2 illustrates two different computing devices that each have a first and a second environment where data may be transmitted between the first and the second environments using light emissions. FIG. 2 includes a first phone 205 and a second phone 250 that may communicate with each other using any communication medium known in the art including yet not limited to cellular data communications, 802.11 communications, Bluetooth communications, communications send via light signals, or other types of communications (e.g. electromagnetic signals).

Phone 205 includes memory 210, CPU 220, and light controller 225 that may be included in a communication environment like communication environment 130 of FIG. 1. Phone 205 also includes Light controller 230, CPU 235, and memory 240 that may be included in an isolated environment like isolated environment 105 of FIG. 1. Phone 250 includes memory 255, CPU 260, and light controller 265 that may be included in a communication environment like communication environment 130 of FIG. 1. Phone 250 also includes Light controller 270, CPU 275, and memory 280 that may be included in an isolated environment like isolated environment 105 of FIG. 1. The different computing environments illustrated in FIG. 2 for each of phone 205 and 250 may communicate with each other according to protocols or rules consistent with the present disclosure. As such of CPU 235 may only receive communications respectively from CPU 220 when a switch at phone 205 is in a particular position. Similarly, CPU 275 may only receive communications respectively from CPU 260 when a switch at phone 250 is in a particular position. The black double arrowed lines in FIG. 2 illustrate that respective communication environments at phone 205 and 250 may communicate with respective isolated environments at phone 205 and 250 according to protocols and rules that are consistent with the present disclosure.

Memories 210 and 255 respective phones 205 and 250 store application program 215A and application program 215B. Application program 215A and 215B may include similar functionality that may allow phone 205 and 250 to communicate with each other using proprietary techniques or by using encryption or decryption keys at each respective phone 205 and 250. These devices may also communicate according to specific protocols or rules. For example, each of these devices may be configured to have synchronized Rivest-Shamir-Adleman (RSA) keys that allows phones 205 and 250 to decrypt communications using keys that change over time. In certain instances, phones 205 and 250 may switch from a first wireless communication medium to a second communication medium to transmit a first and a second portion of a message or a data file between phones 205 and 250. For example, a first communication may be sent via a Bluetooth communication connection and a second communication may be sent via a low power electromagnetic communication using a Keyssa Kiss RF wireless transceiver and then data from the two different communications may be combined to complete the message or the file. In certain, instances such communications may use more than two different types of wireless communications.

Note that memory 240 at phone 205 stores file data 245A, this file data may be data that was decrypted from data transmitted to the communication environment at phone 205. Alternatively this data may have been created or entered via a user interface at phone 205. File data 245A may include any form of data, such as text, audio, video, or some combination of text, audio, or video data. CPU 235 at phone 205 may encrypt file data 245 before that data is sent to phone 250 in transmission 245B of FIG. 2. Once CPU 235 encrypts file data 245A by executing instructions out of memory 240, that encrypted data may be sent via light controllers 230 & 225, such that phone 205 may send that encrypted data to phone 250 according to rules associated with application 215A at phone 205. Phone 250 may receive this data and CPU 260 executing instructions out of memory 255 may send this encrypted data for processing by CPU 275 at phone 250. CPU 275 may then decrypt the data in transmission 245B and store that decrypted data as file data 245C in memory 280 at phone 250. As such, methods consistent with the present disclosure may allow phone 205 to share data with peer devices according to rules consistent with the present disclosure. This could benefit users that receive data from a computer of a central authority who are charted with sharing that information with users of other computing devices. A first user could download information from a central authority, move to locations where others are located and the downloaded information could be secretly shared with other compatible computing devices. Alternatively, information gathered from these other compatible computing devices may be sent to a computing device of a user that can access a computer of the central authority such that intelligence can be passed to the central authority. In certain instances, data sent between respective user devices may not use a publically accessible network, such as a cellular network that may be monitored by agents of a government, for example.

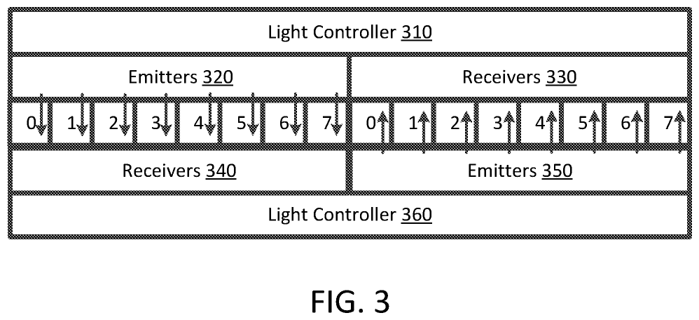

FIG. 3 illustrates an exemplary topology of aligned light emitters and receivers that may be used to transmit data between different computing environments at a computing device. Light controller 310 may be a communication interface that includes emitters 320 and receivers 330, and light controller 310 may be part of a communication environment like the computing environment 130 of FIG. 1. Light controller 360 may be a communication interface that includes receivers 340 and emitters 350, and light controller 340 may be part of an isolated computing environment like isolated the computing environment 105 of FIG. 1. Light controllers 310 and 360 may, therefore, provide an air gap between different computing environments that may only send or receive signals when a switch at a computing device is in a particular position.

Note that a first set of eight black arrows in FIG. 3 indicate that a total of eight emitters 320 can send communication signals to receivers 340 via a first set of light communication channels numbered 0-7. Note also that a second set of eight black arrows in FIG. 3 indicate that a total of eight emitters 350 can send communication signals to receives 330 via a second set of light communication channel also numbered 0-7. In certain instances, light controller 310 may have converted data transmitted from a first processor at a user device using a first number of bits to light controller 310 and light controller 310 may send and receive data using eight bits. Light controller 360 may then convert that received data into one or more sets of data signals before providing that data to a second processor at the user device. Similarly, light controller 360 may convert data received from the second processor into sets of eight bits that are sent to light controller 310 and light controller 310 may then convert that received data into one or more sets of bits when data is provided to the first processor at the user device. As such light controllers 310 & 360 may convert a serial signal into a parallel format and may convert data received in the parallel format back into a serial signal.

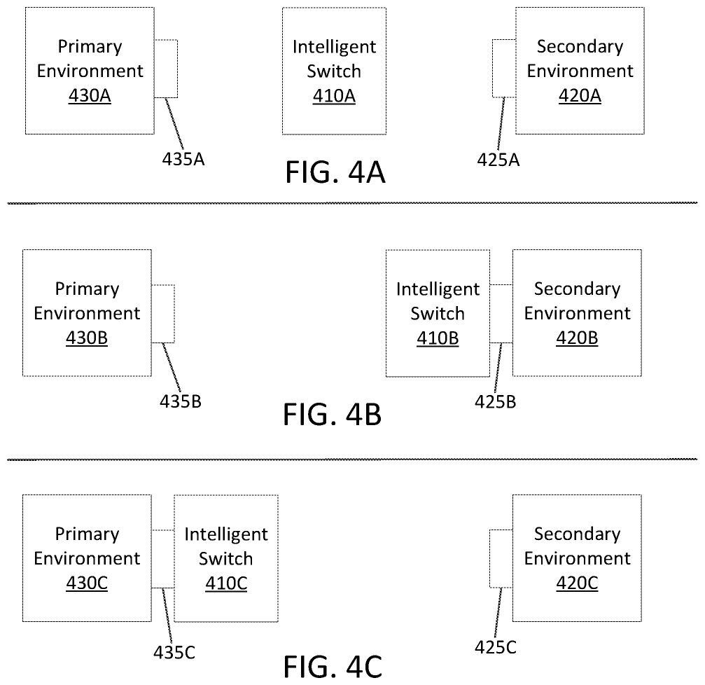

FIGS. 4A, 4B, and 4C conceptually illustrate different connection configurations consistent with the present disclosure. FIG. 4A illustrates a configuration where three different components of a system are communicatively disconnected/isolated from each other. The configuration of FIG. 4A may be referred to as a neutral configuration because intelligent switch 410A is not communicatively coupled to secondary environment 420A or to primary environment 430A. The system of FIGS. 4A, 4B, and 4C may be incorporated into a single computing device, where intelligent switch 410A, secondary environment 420A, and primary environment 430A may be contained within a single enclosure. Alternatively, intelligent switch 410A, secondary environment 420A, and primary environment 430A may be included in one or more separate devices.

FIG. 4A includes intelligent switch 410A, secondary environment 420A, interconnection 425A, primary environment 430A, and interconnection 425B. Note that switch 410A is communicatively disconnected from both secondary environment 420A and from primary environment 430A. In such a configuration, intelligent switch 410A may be separated from secondary environment 420A and primary environment 430A by an “air-gap.” Such air-gaps may prevent the intelligent switch from being physically electrically connected to secondary environment 420A or primary environment 430A. Physical interconnections 425A and 435A may allow intelligent switch 410A to be connected to secondary environment 420A or primary environment 430A by switches that form direct electrical connections where certain electrical conductors may form a communication pathway between intelligent switch 410A and secondary environment 420A, for example. These electrical conductors may be electrically connected by a switch that may include a transistor, field effect transistor (FET), a relay, or other switching device. Switches used to isolate one environment from another may alternatively be a manual switch that requires a user to activate the switch. Such physical switches may be any type of mechanical switch known in the art capable of switching electrical contacts from one configuration to another. Examples of such switches include, yet are not limited to a slide switch or magnetically actuated switches. All a user would have to do is move the switch or move a magnet close to a magnetic switch to change from using electronic components of the primary environment 430A to using electronic components of secondary environment 420A. Switches included in an apparatus consistent with the present disclosure may not be visible on an outer portion of the apparatus. For example, a switch may be hidden under a cover or case of the apparatus or a magnetic switch may be placed on an internal portion of the apparatus in a location where a magnet may be placed over the switch when a secure mode of operation is initiated.

In certain instances, these switches may connect a parallel communication bus or a serial communication connection and use wireless data communication signals such as those described in respect to FIG. 3. Parallel communication buses or serial communication connections may be implemented using any standard or non-standard communication bus known in the art. As such, parallel communications may be performed using any interface including, yet not limited to a local communication bus, a peripheral communication (PCI) bus, an Ethernet connection, a universal serial bus (USB), PCI express (PCIe), or other form of direct communication connection.

While methods and systems consistent with the present disclosure may use direct electrical interconnections, other embodiments may use wireless communication interfaces that may be turned off. In such instances, these wireless communication interfaces may be disabled by a switch, for example by a switch that turns off power to electronics associated with a wireless transmitter or receiver could disable reception or transmission of wireless signals. Alternatively a wireless transmission device or antenna may simply be switched out of a circuit when a communication pathway is disabled.

FIG. 4B illustrates an exemplary configuration consistent with the present disclosure. FIG. 4B includes intelligent switch 410B, secondary environment 420B, interconnection 425B, primary environment 430B, and interconnection 435B. FIG. 4B illustrates a configuration where intelligent switch 410B is communicatively coupled to secondary environment 420B and is not communicatively coupled to primary environment 430B. Communications between intelligent switch 410B and 420B may be initiated after secondary environment 420B has received data from an external computer or from a connectable memory device like a USB memory stick. In such an instance, secondary environment 420B and intelligent switch 410B may include a secondary communication mechanism (not illustrated) that may inform intelligent switch 410A that computer data has been received from an external computer. Alternatively, intelligent switch 410B may periodically connect with secondary environment 420B to check whether secondary environment 420B has received any new computer data that needs to be tested before it can be passed to primary environment 430B.

When intelligent switch 410B and secondary environment 420B are communicatively connected via interconnect 425B, intelligent switch 410B may receive the computer data from secondary environment 420B. After this point in time, intelligent switch 410B may test the received computer data to see if it contains undesired content. Intelligent switch 410B may perform tests that include pattern matching, whitelist/blacklist comparisons, and or other tests capable of detecting malware, viruses, or spam. Tests performed by Intelligent switch 410B may be performed in the neutral configuration illustrated in FIG. 4A or may be initiated with intelligent switch is receiving information from secondary environment 420B.

In an instance when the tests performed by an intelligent switch identify that computer data received from a secondary environment do not include undesired content, that switch may be communicatively coupled to a primary environment in a configuration illustrated in FIG. 4C, for example.

FIG. 4C illustrates a second exemplary configuration consistent with the present disclosure. FIG. 4C illustrates that intelligent switch 410C is communicatively coupled to primary environment 430C via interconnect 435C. FIG. 4 also illustrates that intelligent switch 410C and secondary environment 420C are not communicatively coupled via interconnect 425C. In the configuration of FIG. 4C, primary environment 430C may receive computer data only after intelligent switch 410C has tested received computer data and identified that the received computer data does not include undesired content. Functionality associated with intelligent switches may be fixed after intelligent an intelligent switch is fabricated. As such, the functionality of an intelligent switch may be programmed one (using a one-time programmable memory/read only memory), may be set using a mask read only memory (ROM), may be implemented by digital logic associated with a field programmable gate array (FPGA) coupled to a one-time only memory/ROM, or may be implemented by other forms of digital logic known in the art.

In an instance where an intelligent switch can sometimes receive communications from a secondary environment via a secondary communication mechanism, that secondary communication mechanism may be disabled (e.g. switched out of the circuit or turned off) when the intelligent switch is communicatively coupled to the primary environment such as the configuration shown in FIG. 4C.

While FIG. 4 illustrates three different environments that include primary environment 430A-B-C, intelligent switch 410A-B-C, and secondary environment 420A-B-C, apparatus consistent with the present disclosure are not required to include three different environments. In certain instances, apparatus consistent with the present disclosure may include two different computing environments. Such an apparatus may include a first environment that may not include an ability to decrypt or display sensitive content and a second environment that may be able to decrypt or display the sensitive content.

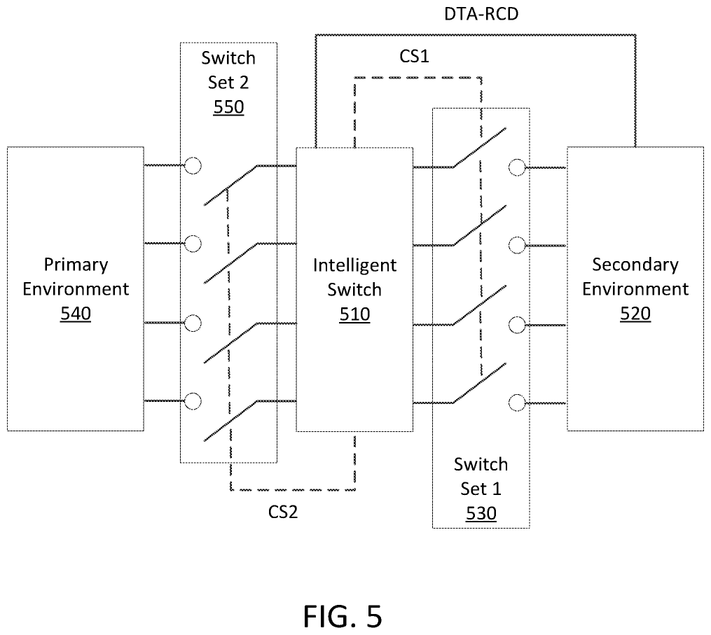

FIG. 5 illustrates exemplary switches that may be used to connect an intelligent switch to either a secondary environment or a primary environment. FIG. 5 includes intelligent switch 510, secondary environment 520, switch set 1 530, primary environment 540, and switch set 2 550. The opening and closing of switches included in switch set 1 530 may be controlled by control signal CS1 and the opening and closing of switches included in switch set 2 550 may be controlled by control signal CS2. Although not illustrated in FIG. 5, secondary environment 520 may include a network interface (wired or wireless) that may receive or send computer data respectively from or to other computing devices.

Control signal CS1 may be used to close the switches of switch set 1 530 to communicatively connect the intelligent switch 510 to the secondary environment 520. Control signal CS2 may be used to close the switches of switch set 2 550 to connect the intelligent switch 510 to primary environment 540. Control signal CS1 may be used to connect the intelligent switch 510 to the secondary environment 520 after data control signal DTA-RCD informs the intelligent switch that computer data has been received by secondary environment 520. Once the switches of switch set 1 530 are closed, communication connections are made such that secondary environment 520 may provide received computer data to intelligent switch 510. At this time primary environment 540 may be protected from hacking, screen-scraping, or key-logging because it is physically isolated from the secondary computing environment and from any external communication path.

After intelligent switch 510 receives the computer data from secondary environment 520, intelligent switch 510 may open the switches of switch set 1 530 and may test the received computer data for undesired content. When intelligent switch 510 identifies that the received computer data does not include undesired content, it may close the switches of switch set 2 550 using control signal CS2. After the switches of switch set 2 550 are closed, intelligent switch 510 may provide the received computer data to primary environment 540. Preferably, switches associated with switch set 1 530 and switch set 2 550 will never be closed at the same time.

In certain instances, logic or processors at a secondary environment may perform a first set of initial tests on received computer data. The secondary environment may be configured to only transmit computer data to an intelligent switch only after this first set of initial tests pass. Intelligent switches 510, the secondary environment 520, or the primary environment 540 may include logic or processors that may perform functions consistent with the present disclosure. Intelligent switch 510 may be implemented using a set of field effect transistors (FETs) or bipolar transistors.

Various environments consistent with the present disclosure may include different forms of functionality. For example, secondary environments discussed in respect to FIGS. 4-5 may include operating system (OS) software (e.g. Android™ compatible OS software), application programs, and one or more data sources (vectors). Such data sources/vectors may include a communication interface wired or wireless, a universal serial bus (USB) port wireless or physical, another secure digital (SD) card, sensors, or other interfaces. A primary environment may include a JAVA OS, a user interface, and user data storage, for example.

Primary environments and secondary environments consistent with the present disclosure may never be physically connected together at any time. A user associated with the primary environment may communicate securely with a second user device operated by a second user. After a message is received in the secondary environment from the second user device, an intelligent switch may be communicatively coupled to the secondary environment after which content included in the received message may be tested an provided to the primary environment securely according to the switching configurations and testing discussed in respect to FIGS. 4-5.

The functionality of a secondary environment and an intelligent switch may be combined, when desired. In such instances, a switch set may isolate functions of an intelligent switch from the secondary environment via switches or wireless components that are enabled or disables based on a position of a switch. While the ability to isolate an intelligent switch from a secondary environment and from a primary environment may be preferred, alternative embodiments may couple the secondary environment to the intelligent switch without switches. This may include coupling the secondary environment to the intelligent switch via a proprietary communication interface or by using a proprietary communication technique. In such instances, the primary environment may only receive computer data after it has been tested and after a connection has been formed via operation of the intelligent switch that allows the primary environment to receive the tested computer data.

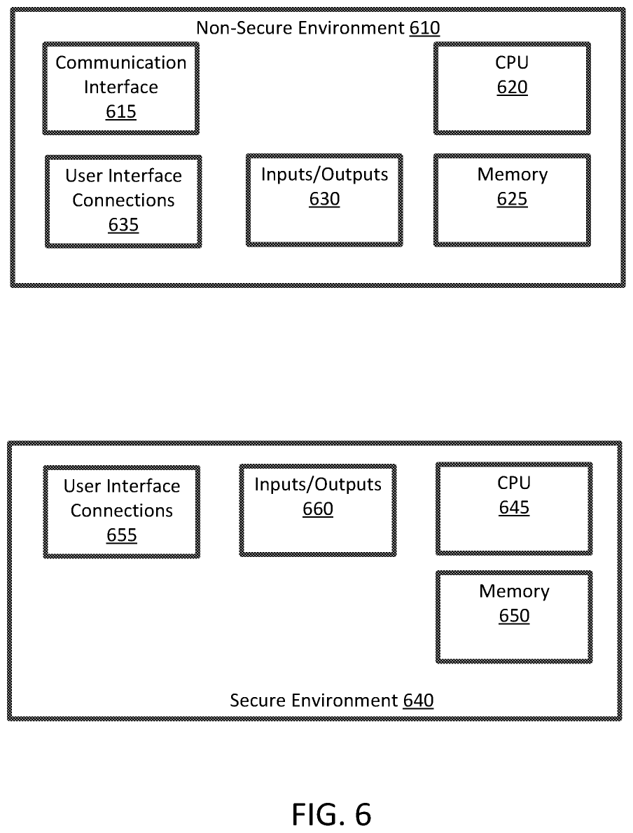

FIG. 6 illustrates components that maybe included in a non-secure (not isolated) environment and in a secure (isolated) environment. Non-secure environment 610 of FIG. 6 includes communication interface 615, CPU (or processor) 620, memory 625, inputs/outputs 630, and user interface connection 635. Secure environment 640 includes CPU (or processor) 645, memory 650, user interface connections 655, and input/outputs 660. Note that communication interface 615 may allow non-secure environment 610 to receive communications from external computing devices. As such communication interface 615 may allow computing devices consistent with the present disclosure to receive or to provide data to a computer via the Internet or other communication network. CPU 620 may execute instructions out of memory 625 when computer data is received or when evaluations are performed on received computer data. Inputs/outputs 630 may allow non-secure environment 610 to send or receive information to or from secure environment 640. In certain instances information may be transmitted through other devices associated with intelligent switch 410A of FIG. 4A. This may allow a processor that is not part of either non-secure environment 610 or secure environment 640 to analyze received computer data for the presence of malware when each of the non-secure environment 610 or the secure environment 640 are disconnected from another environment. User interface connections 655 may allow CPU 620 of non-secure environment 610 to control content displayed on a display or to control content that is provided to a speaker or headphone when a non-secure mode of operation is active. CPU 645 may receive information from non-secure environment 610 or from another processor via inputs/outputs 660. CPU 645 may execute instructions out of memory 650 when preparing to provide data for display on a display or when providing data to a speaker. User interface connection 655 may allow CPU 645 to provide information to the display or speaker, after a secure mode of operation has been initiated. As such, the operating environments 610 and 640 of FIG. 6 may be similar to communication environment 130 and isolated environment 105 of FIG. 1.

CPU 620 of non-secure environment 610 and CPU 645 of secure environment 640 may be processors of different types, may be processors that execute program instructions associated with different types of operating systems, or may be processors of different types that also execute different types of operating system program code. As such, CPU 620 could be an ARM processor and CPU 645 could be an Intel compatible processor. As such, the ARM processor could execute program code associated with a first type of software that is ARM compatible and the Intel compatible processor could execute program code consistent with the Microsoft Windows operating system, for example. Different types of processors and different types of program code operating in respective different environments should make computing devices consistent with the present disclosure less likely to be exploited by a set of malware. Even if malware were able to affect one environment, it would likely not be able to affect both environments.

Here again switches may be used to switch between different operating environments depending a position of one or more switches. Switches discussed in respect to FIGS. 3-4 may cause CPU 645 to initiate the execution of program code instructions consistent with operation of secure environment 645 or may disable the execution of instructions by CPU 645. When these switches are in a first position, operations consistent with non-secure environment 610 may be performed and user interface connections 635 may be connected to a display of a user device. When the switches are in a second position, operations consistent with secure environment 640 may be performed or initiated and user interface connections 655 may be connected to the display of the user device. Other user interface connections that may be switched may include connections to a speaker or to a microphone.

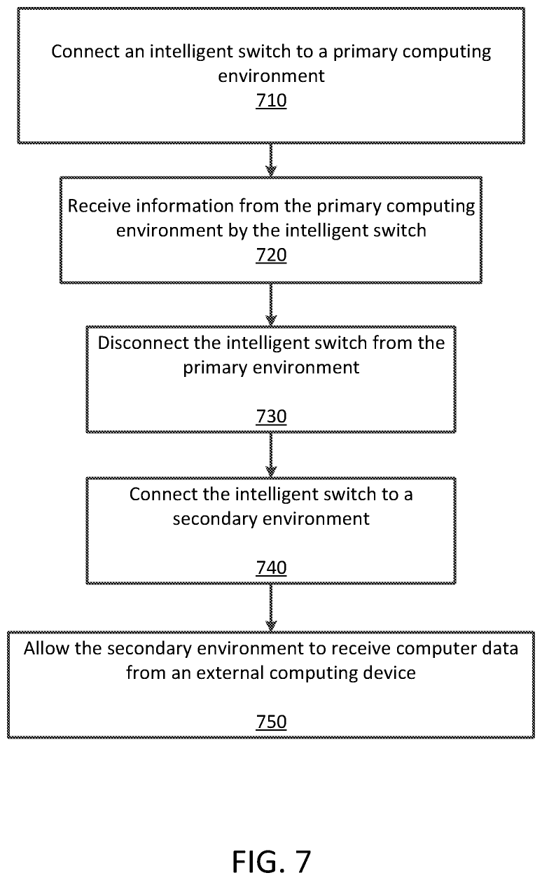

FIG. 7 illustrates an exemplary flow of actions consistent with the present disclosure that may be performed when a user wishes to access content from a remote computing device. In such an instance access requests from the primary environment may be passed to an intelligent switch, such that the intelligent switch may cause a processor associated with the secondary environment to access a website at the Internet, for example. Step 710 of FIG. 7 is where an intelligent switch switches from a neutral position where it may not be communicatively coupled to any other environment to being communicatively coupled to a primary computing environment. This communicative coupling may be implemented by switching one or more switches that make physical electrical interconnections or that enable or disable the coupling of data. Alternatively, communications between the primary environment and the intelligent switch may be performed via wireless communications. The enabling of communications between the primary environment and the intelligent switch may be performed periodically or may be performed based on a communication sent by a secondary means from the primary environment to the intelligent switch. Here again a secondary communication means may include a single communication signal that switches state.

After the intelligent switch connects the primary environment to the intelligent switch in step 710, information from the primary environment may be received by the intelligent switch at step 720 of FIG. 7. The information received from the primary environment may be a request to access information at a server or website. Such a request could include or be related to accessing information associated with a universal resource locator (URL), for example. The intelligent switch may then disconnect from the primary environment in step 730 and then connect to the secondary environment in step 740 of FIG. 7.

After step 740, the secondary environment may be allowed to access data from an external computing device. For example, a URL provided with a request received from the primary environment in step 720 may be accessed by the secondary environment. As such, intelligent switches consistent with the present disclosure may selectively connect to either a primary or to a secondary computing environment based on a protocol that may include periodic switching, secondary communications, or proprietary communications that can cause the primary computing environment to always be disconnected/isolated from the secondary computing environment. By doing this, methods and apparatus consistent with present disclosure constitute a new form of “air-gapping” of specific parts of an overall computing system when performing a security function.

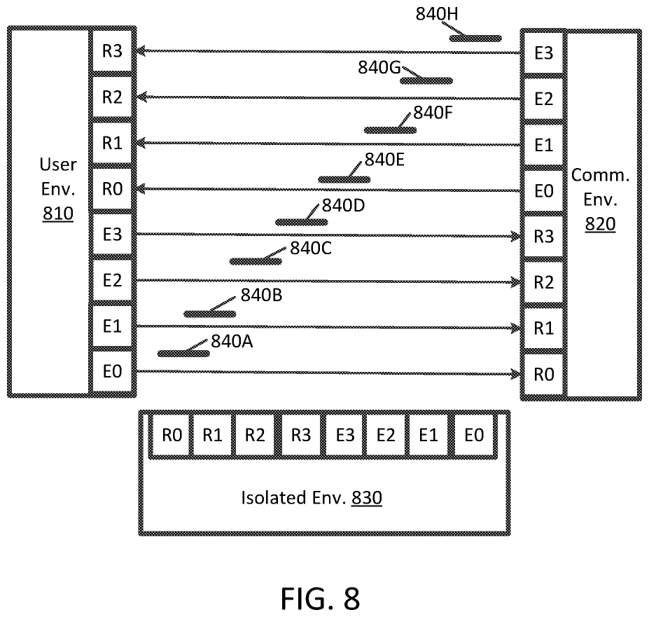

FIG. 8 illustrates different environments where a set of components in a user interactive environment may receive data from and provide data to electronics included in a communication environment or in an isolated environment depending on the position of a switch. FIG. 8 includes communication environment 820, and isolated environment 830 that may independently receive light signals from or provide light signals to user interactive environment 810. User environment 810, communication environment 810, and isolated environment 830 may also include electronic components illustrated in the user interaction environment 160, the communication environment 130, and the isolated environment 105 of FIG. 1.

FIG. 8 also includes different sets of emitters E0-E3 (E0, E1, E2, & E3) and receivers R0-R3 (R0, R1, R2, & R3) that may be used to transmit light signals via micromechanical system (MEMS) mirrors 840A-840H (840A, 840B, 840C, 840D, 840E, 840F, 840G, & 840H). MEMS mirrors are small mirrors that may be moved into different orientations using electronic control signals. These electronic control signals may cause an orientation of a MEMS mirror to move in a manner that causes light from a light/infrared source (e.g. an emitter) to be reflected to any number of desired directions. Methods consistent with the present disclosure may cause MEMS mirrors to be oriented into different positions such that signals from respective one or more light/infrared emitters may be directed to respective one or more different light/infrared receivers.

Note that the position of MEMS mirrors 840A-840H cause light signals to travel between user environment 810 and communication environment 820. Positions of the MEMS mirrors may be changed to reflect signals in different directions or may allow signals to pass in a desired direction based on the position of a switch. While FIG. 8 illustrates MEMS mirrors 840A-840H allowing light signals to pass by without reflection (as shown by the arrowed lines), MEMS mirrors 840A-840H could be oriented to reflect light signals to communicatively couple user environment 810 and communication environment 820 when these two environments are not directly aligned. When such a switch is in a first position, electronics in communication environment 820 may receive data from and provide data to electronics in user environment 810. At this time, isolated environment 830 may not send data to or receive data from user environment 810 because of the position of MEMS mirrors 840A-840H. At this time, power provided to circuits that control receivers and emitters of isolated environment 830 may be disconnected.

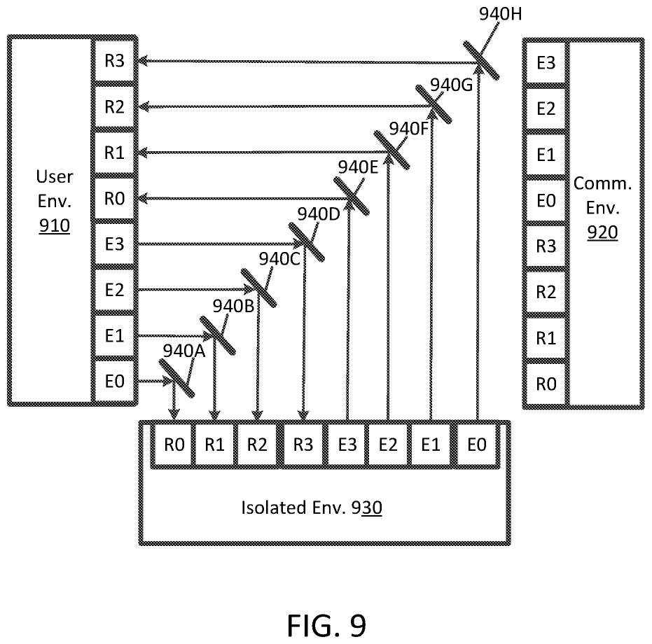

FIG. 9 illustrates the same sets of different environments that were illustrated in FIG. 8, here however, the position of a set of micromechanical system mirrors direct signal communications between a user interactive environment and an isolated environment. FIG. 9 includes communication environment 920 and isolated environment 930 that may independently receive light signals from or provide light signals to user interactive environment 910. User environment 910, communication environment 910, and isolated environment 930 may also include electronic components illustrated in the user interaction environment 160, the communication environment 130, and the isolated environment 105 of FIG. 1.

FIG. 9 also includes different sets of emitters E0-E3 (E0, E1, E2, & E3) and receivers R0-R3 (R0, R1, R2, & R3) that may be used to transmit light signals via micromechanical system (MEMS) mirrors 940A-940H (940A, 940B, 940C, 940D, 940E, 940F, 940G, & 940H). Note that the position of MEMS mirrors 940A-940H cause light signals to travel between user environment 910 and isolated environment 930 based on a light from different emitters being reflected as indicated by the arrowed lines in FIG. 9. Positions of the MEMS mirrors may be changed to reflect signals in different directions or may allow signals to pass in a desired direction based on the position of the switch as discussed in respect to FIG. 8. When this switch is in a second position, electronics in isolated environment 930 may receive data from and provide data to electronics in user environment 910. At this time, communication environment 920 may not send data to or receive data from user environment 910 because of the position of MEMS mirrors 940A-940H. At this time power provided to circuits that control receivers and emitters of isolated environment 930 may be disconnected.

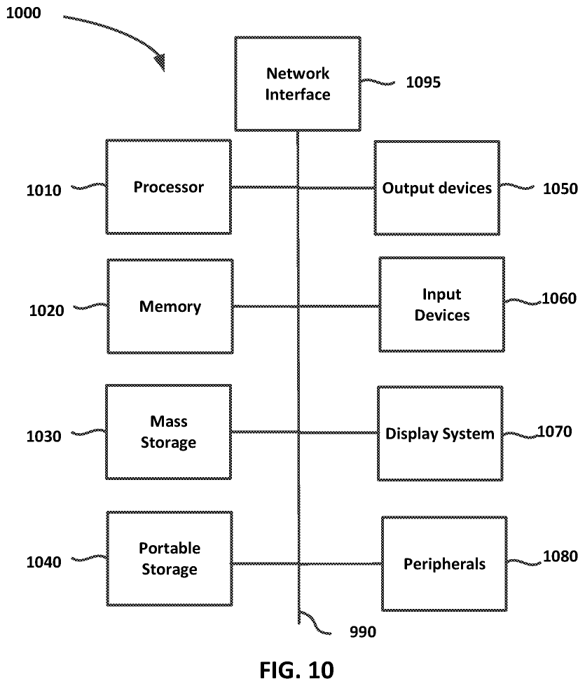

FIG. 10 illustrates a computing system that may be used to implement an embodiment of the present invention. The computing system 1000 of FIG. 10 includes one or more processors 1010 and main memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, peripheral devices 1080, and network interface 1095.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a FLASH memory, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD), a plasma display, an organic light-emitting diode (OLED) display, an electronic ink display, a projector-based display, a holographic display, or another suitable display device. Display system 1070 receives textual and graphical information, and processes the information for output to the display device. The display system 1070 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 1080 may include any type of computer support device to add additional functionality to the computer system. For example, peripheral device(s) 1080 may include a modem or a router.

Network interface 1095 may include any form of computer interface of a computer, whether that be a wired network or a wireless interface. As such, network interface 1095 may be an Ethernet network interface, a BlueTooth™ wireless interface, an 802.11 interface, or a cellular phone interface.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, FLASH memory, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A secure computing apparatus, the apparatus comprising:
a first set of electronic components that include a first set of wireless data transfer components;
a second set of electronic components that include a second set of wireless data transfer components;
a switch that includes a first position and a second position;
a third set of electronic components that include a display, the third set of electronic components controllably coupled to communicate data between the first set of electronic components or the second set of electronic components based on a position of the switch corresponding to a first position or a second position, wherein:
the first set of electronic components sends data for display on the display when the switch position corresponds to the first position and the second set of electronic components sends data for display on the display when the switch position corresponds to the second position.

2. The apparatus of claim 1, wherein the first set of electronic components also includes a first processor and a first memory and the second set of electronic components also includes a second processor and a second memory.

3. The apparatus of claim 2, wherein the first set of electronic components also include a communication interface that communicates with an external electronic device to receive data.

4. The apparatus of claim 1, further comprising a micromechanical system mirror that reflects an emission from an emitter to a receiver that receives the data sent for display on the display.

5. The apparatus of claim 1, further comprising:
a set of program code;
a memory that stores the set of program code;
a processor that executes instructions of the set of program code out of the memory to:
identify that data received from a peer computing device was sent from the peer computing device; and
allow content included in the data received from the peer computing device to be displayed on the display based at least in part of the identification that the data was sent from the peer computing device.

6. The apparatus of claim 1, wherein a voltage that powers at least one component of the second set of wireless data transfer components is disconnected when the switch is in the first position.

7. The apparatus of claim 6, wherein a voltage that powers at least one component of the first set of wireless data transfer components is disconnected when the switch is in the second position.

8. The apparatus of claim 1, further comprising:
a first set of digital logic of the first set of electronic components that converts a serial stream of data bits to one or more sets of parallel data bits for transmission to the display via the first set of wireless data transfer components; and
a second set of digital logic at the third set of electronic components that converts the one or more sets of parallel data bits to the serial stream of data bits.

9. A method for protecting computer data, the method comprising:
executing instructions out of a first memory by a first processor when a switch is in a first position;
providing a first set of data for display on a display via a first set of wireless data transfer components when the switch is in the first position, wherein the first set of data provided via the first set of wireless data transfer components are displayed on the display based on execution of the instructions out of the first memory by the first processor;
executing instructions out of a second memory by a second processor when the switch is in a second position; and
providing a second set of data for display on the display via a second set of wireless data transfer components when the switch is in the second position, wherein the second set of data provided via the second set of wireless data transfer components are displayed on the display based on execution of the instructions out of the second memory by the second processor.

10. The method of claim 9, further comprising:
receiving data from a peer computing device;
executing instructions by the first processor out of the first memory to identify that the received data was received from the peer computing device; and
allow content included in the data received from the peer computing device to be displayed on the display based at least in part of the identification that the data was sent from the peer computing device.

11. The method of claim 9, further comprising:
receiving data from an external computing device;
scanning the data received from the external computing device for undesired content;
identifying that the data received from the external computing device can be provided to the second processor for processing; and
sending the received data via a third set of wireless data transfer components for processing at the second processor.

12. The method of claim 9, further comprising:
encrypting data by the second processor;
sending the encrypted data to the first processor for transmission to an external computing device; and
sending the encrypted data to the external computing device.

13. The method of claim 9, wherein a voltage that powers at least one component of the second set wireless data transfer components is disconnected when the switch is in the first position.

14. The method of claim 13, wherein a voltage that powers at least one component of the first set wireless data transfer components is disconnected when the switch is in the second position.

15. A non-transitory computer-readable storage medium having embodied thereon one or more programs executable by one or more processors to implement a method for protecting computer data, the method comprising:
executing instructions out of a first memory by a first processor when a switch is in a first position;
providing a first set of data for display on a display via a first set of wireless data transfer components when the switch is in the first position, wherein the first set of data provided via the first set of wireless data transfer components are displayed on the display based on execution of the instructions out of the first memory by the first processor;
executing instructions out of a second memory by a second processor when the switch is in a second position; and
providing a second set of data for display on the display via a second set of wireless data transfer components when the switch is in the second position, wherein the second set of data provided via the second set of wireless data transfer components are displayed on the display based on execution of the instructions out of the second memory by the second processor.

16. The non-transitory computer-readable storage medium of claim 15, wherein:
data is received from a peer computing device;
instructions are executed by the first processor out of the first memory to identify that the received data was received from the peer computing device;
content included in the data received from the peer computing device is allowed to be displayed on the display based at least in part of the identification that the data was sent from the peer computing device.

17. The non-transitory computer-readable storage medium of claim 15, wherein:
data from an external computing device is received;
the data received from the external computing device is scanned for undesired content; and
the received data is sent via a third set of wireless data transfer components for processing at the second processor based on an identification that the data can be provided to the second processor for processing.

18. The non-transitory computer-readable storage medium of claim 15, wherein:
encrypt data by the second processor encrypts data;
the encrypted data is sent to the first processor for transmission to an external computing device; and
the encrypted data is sent to the external computing device.

19. The non-transitory computer-readable storage medium of claim 15, wherein a voltage that powers at least one component of the second set wireless data transfer components is disconnected when the switch is in the first position.

20. The non-transitory computer-readable storage medium of claim 19, wherein a voltage that powers at least one component of the first set wireless data transfer components is disconnected when the switch is in the second position.
